(19) United States
(12) Patent Application Publication
(10) Pub. No.: US 2016/0264028 A1
(43) Pub. Date: Sep. 15, 2016

(54) CENTRIFUGAL BLOWER

(71) Applicant: DENSO CORPORATION, Kariya-city, Aichi (JP)

(72) Inventors: Masafumi KAWASHIMA, Kariya-city (JP); Fumiya ISHII, Kariya-city (JP)

(73) Assignee: DENSO CORPORATION, Kariya-city, Aichi-pref. (JP)

(21) Appl. No.: 15/030,329

(22) PCT Filed: Oct. 14, 2014
(86) PCT No.: PCT/JP2014/005196

§ 371 Date: Apr. 18, 2016

(30) Foreign Application Priority Data
Oct. 21, 2013 (JP) 2013-218367
Jul. 16, 2014 (JP) 2014-145611

(51) Int. Cl. B60N 2/56; F04D 29/42; F04D 29/02; F04D 29/28; F04D 29/16; F04D 25/06

(52) U.S. Cl. CPC B60N 2/565; F04D 29/162; F04D 25/0606; F04D 29/023; F04D 29/281; F04D 29/4226

(57) ABSTRACT

A case housing a centrifugal fan has a suction-side surface provided with a suction port, and two case-side protruding parts that are formed in an annular shape when viewed in an axial direction and protrude toward a centrifugal fan are provided with the suction-side surface. The centrifugal fan has an upper-surface-side plate that is arranged to face the suction-side surface, and the upper-surface-side plate is provided with a fan-side protruding part that is formed in an annular shape when viewed in the axial direction and protrudes toward the suction-side surface. A gap between the two case-side protruding parts in a radial direction is filled with a grease. The fan-side protruding part has a tip portion formed to have a shape that is tapered gradually toward a direction in which the fan-side protruding part protrudes, and the tip portion is in contact with the grease.

### CROSS REFERENCE TO RELATED APPLICATIONS

This application is based on Japanese Patent Application No. 2013-218367 filed on Oct. 21, 2013 and Japanese Patent Application No. 2014-145611 filed on Jul. 16, 2014, the disclosure of which is incorporated herein by reference.

### TECHNICAL FIELD

The present disclosure relates to a centrifugal blower.

### BACKGROUND ART

Conventionally, a centrifugal blower is known to have a centrifugal fan and a case. The centrifugal fan draws air in an axial direction of a rotational axis and blows the air in a radial direction. The case houses the centrifugal fan and is provided with a suction port and a blowing port for the air. In this kind of centrifugal blower, since the centrifugal fan rotates in the case, the centrifugal fan and the case are usually arranged to avoid being in contact with each other to restrict a sliding friction between the centrifugal fan and the case.

However, when a dimension of a gap formed between the centrifugal fan and the case is set to be large to prevent the centrifugal fan and the case from being in contact with each other, the air blown from the centrifugal fan counterflows toward the suction port, and a fan efficiency ηf may deteriorate. The fan efficiency ηf is a ratio of a theoretical aerodynamic power with respect to a rotational driving force (i.e., a shaft power) that is necessary to rotate the centrifugal fan. The theoretical aerodynamic power is shown by a value equivalent to a work load that is output by the centrifugal blower.

In contrast, in a centrifugal fan of Patent Literature 1, a protruding part (i.e., a bellows) that protrudes toward the centrifugal fan is provided at a suction port that is open in a case, and the bellows and an upper-surface-side plate of the centrifugal fan form substantially no gap therebetween. Accordingly, air blown from the centrifugal fan is prevented from counterflowing toward the suction port. The upper-surface-side plate is a plate member that is arranged to face a suction-side surface of the case of the centrifugal fan provided with the suction port.

### PRIOR ART LITERATURES

### Patent Literature

Patent Literature 1: JP 2010-248941 A

### SUMMARY OF INVENTION

However, even if a counterflow is suppressed by setting a gap between the bellows of the case and the upper-surface-side plate of the centrifugal fan to be substantially zero as described in the centrifugal blower of Patent Literature 1, the sliding friction between the centrifugal fan and the case cannot be suppressed when the centrifugal fan moves by a vibration and is in contact with the case while operating the centrifugal blower. As a result, the shaft power of the centrifugal fan increases, and a required aerodynamic power (i.e., a work load of the centrifugal blower) may not be achieved.

The present disclosure addresses the above-described issues, and it is an objective of the present disclosure to prevent an air, which is blown from the centrifugal blower, from counterflowing toward a suction port and to suppress an increase of a shaft power of the centrifugal fan.

A centrifugal fan according to a first aspect of the present disclosure has a centrifugal fan and a case. The centrifugal fan rotates by a rotational driving force transmitted thereto, draws air in an axial direction of a rotational axis, and blows the air in a radial direction. The case houses the centrifugal fan and is provided with a suction port for the air.

The centrifugal fan has blades and an upper-surface-side plate. The blades are arranged annularly around a rotational axis. The blades are fixed to the upper-surface-side plate, and the upper-surface-side plate is arranged to face an suction-side surface of the case provided with the suction port. The suction-side surface and the upper-surface-side plate form a gap therebetween, and a sealing member made of a semisolid material is arranged in the gap. The sealing member is in contact with both the suction-side surface and the upper-surface-side plate and is disposed around the rotational axis to have an annular shape when viewed in the axial direction.

The sealing member is disposed in the gap formed between the suction-side surface of the case and the upper-surface-side plate of the centrifugal fan, and the sealing member is arranged annularly to be in contact with both the suction-side surface and the upper-surface-side plate. Accordingly, the air blown from the centrifugal fan can be prevented from counterflowing toward the suction port through the gap formed between the suction-side surface and the upper-surface-side plate.

Furthermore, since the centrifugal fan and the case is not in contact with each other directly, the sliding friction between the centrifugal fan and the case can be suppressed. Therefore, an increase of the shaft force of the centrifugal fan can be suppressed.

As a result, a centrifugal fan with which the air blown from the centrifugal blower can be prevented from counterflowing toward a suction port, and with which the increase of the shaft power of the centrifugal fan can be suppressed can be provided.

A centrifugal fan according to a second aspect of the present disclosure has a centrifugal fan and a case. The centrifugal fan rotates by a rotational driving force transmitted thereto, draws air in an axial direction of a rotational axis, and blows the air in a radial direction. The case houses the centrifugal fan and is provided with a suction port for the air.

The centrifugal fan has blades and an upper-surface-side plate. The blades are arranged annularly around a rotational axis. The blades are fixed to the upper-surface-side plate, and the upper-surface-side plate is arranged to face a suction-side surface of the case provided with the suction port. The suction-side surface has a case-side protruding part that is formed in an annular shape when viewed in the axial direction and protrudes toward the upper-surface-side plate. The upper-side-surface plate has a fan-side protruding part that is formed in an annular shape when viewed in the axial direction and protrudes toward the suction-side surface. At least one of the case-side protruding part and the fan-side protruding part is one protruding part of a plurality of protruding parts. A sealing member is disposed between adjacent protruding parts of the plurality of protruding parts. An other protruding part of the case-side protruding part and the fan-side protruding part has a tip portion that is in contact with the sealing member. The tip portion has an axial cross section of which sectional shape is tapered gradually toward a direction in which the protruding part protrudes.

One of the case-side protruding part and the fan-side protruding part is one protruding part of a plurality of protruding parts, and the sealing member is disposed between adjacent protruding parts of the plurality of protruding parts. The other one of the case-side protruding part and the fan-side protruding part has the tip portion that is in contact with the sealing member. Accordingly, the air blown from the centrifugal fan can be prevented from counterflowing toward the suction port through the gap formed between the suction-side surface of the case and the upper-surface-side plate of the centrifugal fan.

In this case, since the sealing member is made of a semisolid material, the tip portion of the other one of the case-side protruding part and the fan-side protruding part can be in contact with the sealing member easily even if a dimension of the other one of the case-side protruding part and the fan-side protruding part is slightly different from a required dimension when forming the other protruding part of the case-side protruding part and the fan-side protruding part. Therefore, when forming the other protruding part of the case-side protruding part and the fan-side protruding part, the other protruding part of the case-side protruding part and the fan-side protruding part can be formed easily without an advanced tolerance management.

Furthermore, since the centrifugal fan and the case is not in contact with each other directly, the sliding friction between the centrifugal fan and the case can be suppressed. In addition, the tip portion has the axial cross section of which sectional shape is tapered gradually toward the direction in which the protruding part protrudes. Therefore, by decreasing a contact area between the tip portion and the sealing member, an increase of the shaft force of the centrifugal fan can be suppressed. Therefore, an increase of the shaft force of the centrifugal fan can be suppressed.

As a result, the air blown from the centrifugal blower can be prevented from counterflowing toward a suction port, and the increase of the shaft power of the centrifugal fan can be suppressed.

A centrifugal blower according to a third aspect of the present disclosure has a centrifugal fan and a case. The centrifugal fan rotates by a rotational driving force transmitted thereto, draws air in an axial direction of a rotational axis, and blows the air in a radial direction. The case houses the centrifugal fan and is provided with a suction port for the air.

The centrifugal fan has blades and an upper-surface-side plate. The blades are arranged annularly around a rotational axis. The blades are fixed to the upper-surface-side plate, and the upper-surface-side plate is arranged to face a suction-side surface of the case provided with the suction port. The suction-side surface has a case-side protruding part that is formed in an annular shape when viewed in the axial direction and protrudes toward the upper-surface-side plate. The upper-side-surface plate has a fan-side protruding part that is formed in an annular shape when viewed in the axial direction and protrudes toward the suction-side surface.

The case-side protruding part and the fan-side protruding part constitute a labyrinth seal in a gap formed between the suction-side surface and the upper-surface-side plate. A dimension between the suction-side surface and the upper-surface-side plate on an inner peripheral side of the labyrinth seal is smaller than a dimension between the suction-side surface and the upper-surface-side plate on an outer peripheral side of the labyrinth seal in an axial cross section of the gap formed between the suction-side surface and the upper-surface-side plate.

The case-side protruding part and the fan-side protruding part constitute the labyrinth seal in the gap formed between the suction-side surface and the upper-surface-side plate. The dimension of the gap on the inner peripheral side (i.e., a rotational axis side) of the labyrinth seal is smaller than the dimension of the gap on the outer peripheral side.

Accordingly, the air blown from the centrifugal fan can be effectively prevented from counterflowing toward the suction port through the gap formed between the suction-side surface of the case and the upper-surface-side plate of the centrifugal fan.

Moreover, the centrifugal fan and the case are not in contact with each other directly. Therefore, an increase of the sliding friction between the centrifugal fan and the case can be suppressed. In this case, since a displacement amount of the centrifugal fan due to a vibration or the like is smaller on the inner peripheral side (i.e., the rotational axis side) than that on the outer peripheral side, an increase of the sliding friction, which is caused when a portion of the centrifugal fan and a portion of the case forming an inner periphery of the labyrinth seal are in contact with each other, can be suppressed. Therefore, an increase of the shaft force of the centrifugal fan can be suppressed.

As a result, a centrifugal fan with which the air blown from the centrifugal blower can be prevented from counterflowing toward a suction port, and with which the increase of the shaft power of the centrifugal fan can be suppressed can be provided.

### BRIEF DESCRIPTION OF DRAWINGS

FIG. 1 is a schematic diagram illustrating an entirety of a seat air conditioner according to a first embodiment.

FIG. 2 is a perspective external view illustrating a centrifugal blower of the first embodiment.

FIG. 3 is an exploded perspective view illustrating the centrifugal blower of the first embodiment.

FIG. 4 is a sectional view taken along a line IV-IV shown in FIG. 2.

FIG. 5 is a graph showing a variation of a fan efficiency depending on a variation of a flow coefficient of the centrifugal blower of the first embodiment.

FIG. 6 is a graph showing a variation of a relative noise depending on a variation of the fan efficiency of the blower.

FIG. 7 is a graph showing a variation of a pressure coefficient depending on the flow coefficient of the centrifugal blower of the first embodiment.

FIG. 8 is a graph showing a variation of the relative noise depending on the flow coefficient of the centrifugal blower of the first embodiment.

FIG. 9 is a sectional view illustrating a centrifugal blower of a second embodiment.

FIG. 10 is a sectional view illustrating a centrifugal blower of a third embodiment.

FIG. 11 is a sectional view illustrating a centrifugal blower of a fourth embodiment.

FIG. 12 is a sectional view illustrating a centrifugal blower of a fifth embodiment.

### DESCRIPTION OF EMBODIMENTS

### First Embodiment

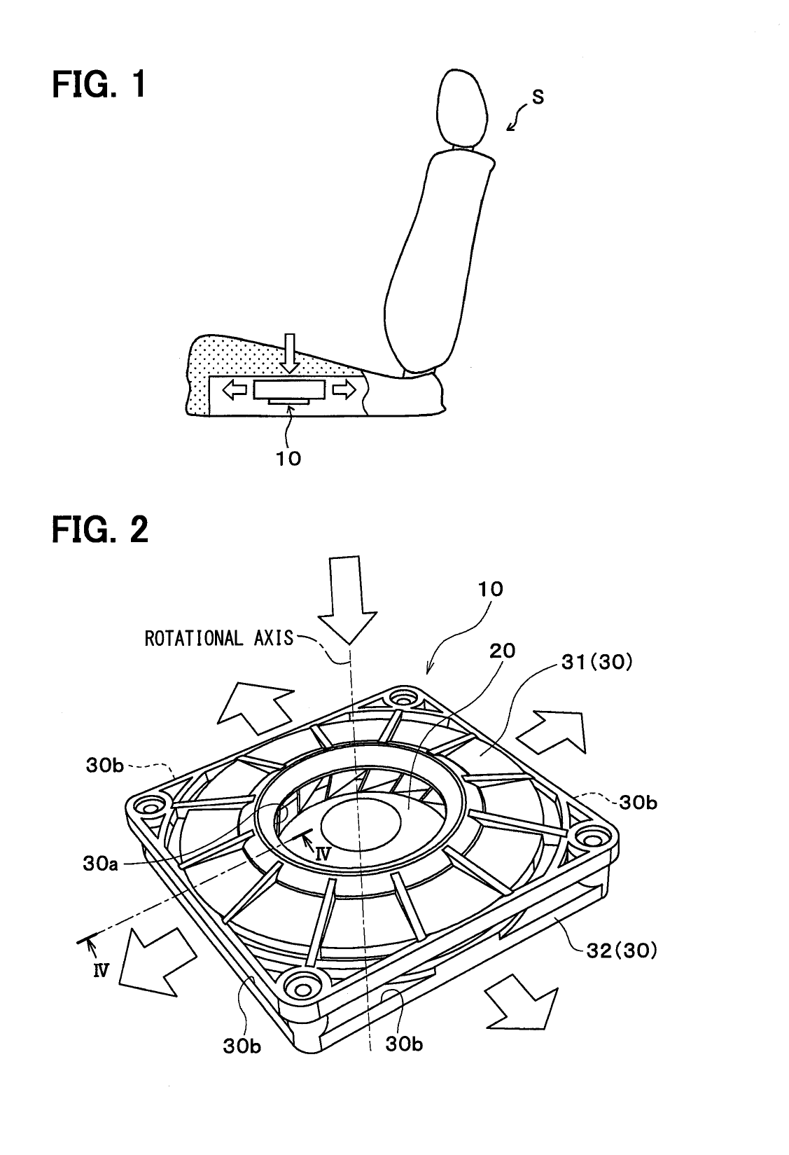

Hereafter, a first embodiment of the present disclosure will be described referring to FIGS. 1 to 7. A centrifugal blower 10 of the present embodiment is used for a seat air conditioner for a vehicle and draws an air from a vehicle compartment in the seat air conditioner.

More specifically, in the seat air conditioner, as shown in FIG. 1, the centrifugal blower 10 is housed in a seat S on which a passenger seats. In a cooling operation, the centrifugal blower 10 is operated to draw air around a surface of the seat S through pores formed on the seat S, such that a cool feeling of the passenger is improved by decreasing a temperature and humidity around a surface of the seat S.

A detail of a structure of the centrifugal blower 10 will be described hereafter. The centrifugal blower 10 of the present embodiment has a centrifugal fan 20 and a case 30 as shown in FIGS. 2 to 4. The centrifugal fan 20 draws air in an axial direction of a rotational axis and blows the air in a radial direction. The case 30 houses the centrifugal fan 20 and has a suction port 30a drawing air into the case 30 and a blowing port 30b blowing air to an outside.

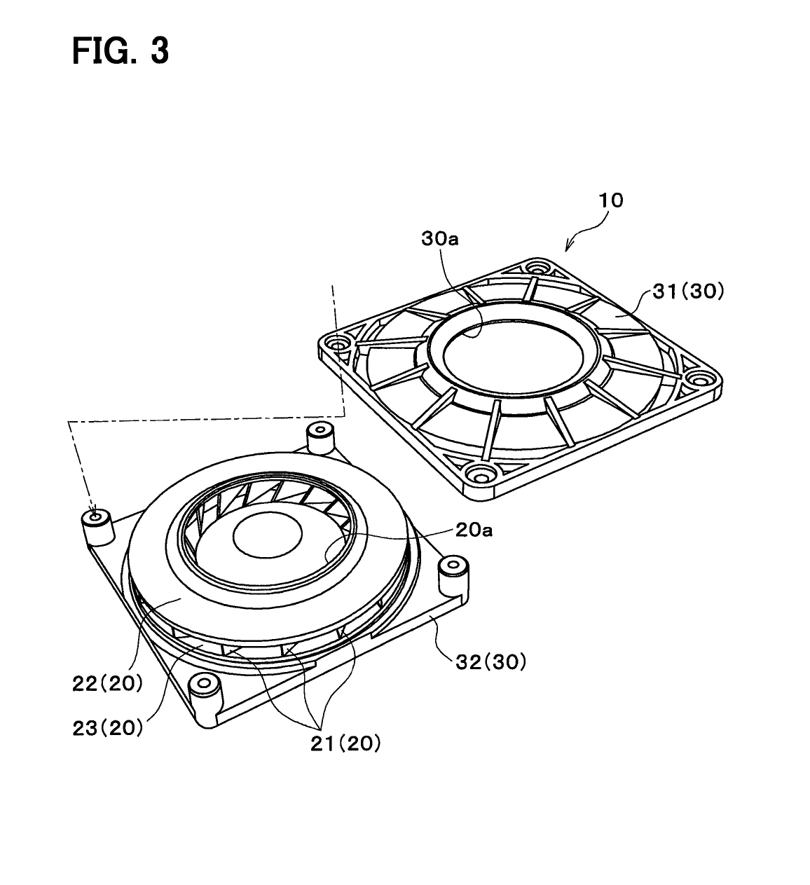

The case 30 is made of resin and has an upper case 31 and a lower case 32. The upper case 31 has the suction port 30a having a discoid shape at a center portion. The lower case 32 has a flat rectangular shape, and a body of an electric motor that will be described after is fixed to the lower case 32. More specifically, as shown in exploded perspective view of FIG. 3, a corner portion of the upper case 31 and a corner portion of the lower case 32 are fixed to each other by a method such as bolting.

The suction port 30a formed in the upper case 31 is arranged coaxially with the rotational axis of the centrifugal fan 20. Further, as shown in FIG. 2, blowing ports 30b are formed in a side surface of the case 30 by a gap formed between the upper case 31 and the lower case 32. The blowing ports 30b are formed between each corner of the upper case 31 and each corner of the lower case 32, thereby four of the blowing ports 30b are formed in the present embodiment.

The centrifugal fan 20 is made of resin and has blades 21, an upper-surface side plate 22, and a lower-surface-side plate 23. The blades 21 are arranged annularly around the rotational axis. The upper-surface-side plate 22 has a generally flat shape that is formed in an annular shape when viewed in the axial direction of the rotational axis. The lower-surface-side plate 23 has a generally conical shape.

More specifically, each of the blades 21 is formed in a shape that slopes oppositely with respect to a rotational direction from a radial inner side to a radial outer side when viewed in the axial direction of the rotational axis. Therefore, the centrifugal fan 20 of the present embodiment is constituted as a backward inclined fan (i.e., a turbo fan). The blades 21 are fixed by being arranged between the upper-surface-side plate 22 and a conical side surface of the lower-surface-side plate 23 in the axial direction of the rotational axis.

The upper-surface-side plate 22 is arranged to face a suction-side surface 31a of the upper case 31 that is provided with the suction port 30a. A fan-side suction hole 20a is provided in a center portion of the upper-surface-side plate 22. The fan-side suction hole 20a has a circular shape and guides air drawn through the suction port 30a of the upper case 31 to flow into the centrifugal fan 20. The fan-side suction hole 20a is arranged coaxially with the rotational axis and forms an innermost periphery of the upper-surface-side plate 22.

The electric motor (not shown) is disposed on an inner peripheral side of the conical surface of the lower-surface-side plate 23, a rotational shaft of the electric motor connects the lower-surface-side plate 23. As described above, the body of the electric motor is fixed to the lower case 32. Accordingly, when a rotational driving force is transmitted from the electric motor to the centrifugal fan 20 (specifically, to the lower-surface-side plate 23), the centrifugal fan 20 rotates in the case 30.

Moreover, according to the present embodiment, a gap is formed between the centrifugal fan 20 and the case 30 such that the centrifugal fan 20 and the case 30 are not in contact with each other directly when the centrifugal fan 20 rotates. Therefore, an increase of the sliding friction between the centrifugal fan 20 and the case 30 is suppressed. An operation of the electric motor is controlled by a control voltage that is output from a controller (not shown).

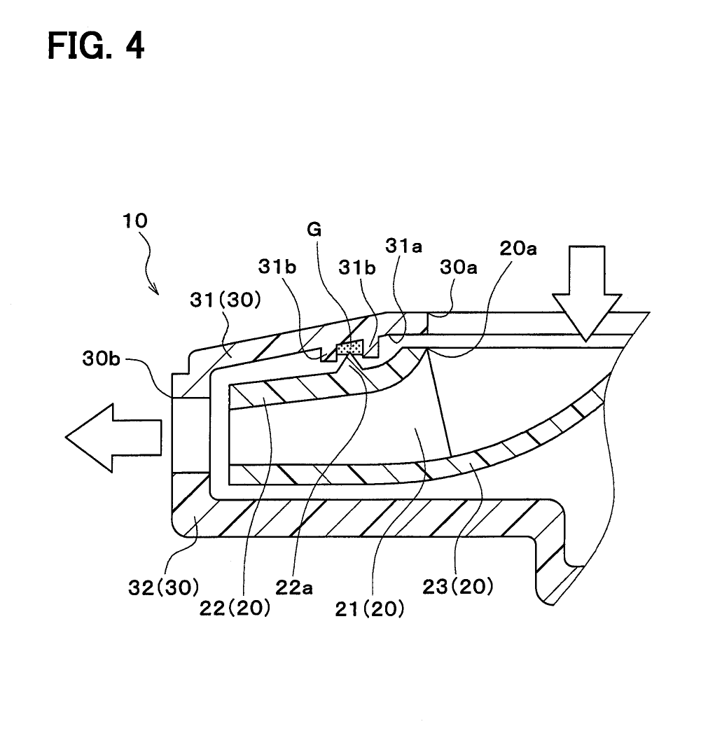

As shown in FIG. 4, the suction-side surface 31a of the upper case 31 of the present embodiment is provided with two case-side protruding parts 31b that protrude in the axial direction of the rotational axis toward the upper-surface-side plate 22 of the centrifugal fan 20. The two case-side protruding parts 31b are formed to have a dimension with which a tip portion 22b is not in contact with the upper-surface-side plate 22.

Furthermore, the two case-side protruding parts 31b are formed in an annular shape of which diameters are different from each other when viewed in the axial direction of the rotational axis, and are arranged coaxially with the rotational axis. A grease G as a sealing member made of a semisolid material fills all along a gap that is formed between the two case-side protruding parts 31b in the radial direction. More specifically, according to the present embodiment, a viscosity of the grease G is about 0.024 Pa≠S, and a kinetic viscosity of the grease G is about 26 cSt.

On the other hand, the upper-surface-side plate 22 of the centrifugal fan 20 is provided with a single fan-side protruding part 22a that protrudes in the axial direction of the rotational axis toward the suction-side surface 31a of the upper case 31. The fan-side protruding part 22a has an annular shape when viewed in the axial direction of the rotational axis and is arranged coaxially with the rotational axis.

Moreover, a diameter of the fan-side protruding part 22a is larger than a diameter of the case-side protruding part 31b on an inner peripheral side and is smaller than a diameter of the case-side protruding part 31b on an outer peripheral side. Therefore, the tip portion 22b of the fan-side protruding part 22a protrudes between the two case-side protruding parts 31b, and the tip portion 22b is in contact with the grease G filling between the two case-side protruding parts 31b all along the grease G.

The tip portion 22b of the fan-side protruding part 22a has an axial cross section of which sectional shape is tapered gradually toward a protruding direction in which the fan-side protruding part 22a protrudes. The sectional shape of the axial cross section is a sectional shape of a cross section including the rotational axis. More specifically, the sectional shape in the axial cross section is tapered to form an acute angle.

That is, according to the present embodiment, the case-side protruding part 31b constitutes one protruding part of the case-side protruding part 31b and the fan-side protruding part 22a, and the fan-side protruding part 22a constitutes the other protruding part of the case-side protruding part 31b and the fan-side protruding part 22a. Further, obviously from FIG. 4, the case-side protruding part 31b and the fan-side protruding part 22a are located to be closer to an innermost periphery (i.e., the fan-side suction hole 20a) of the centrifugal fan 20 than an outermost periphery of the centrifugal fan 20.

An operation of the present embodiment with the above-described structure will be described hereafter. In the centrifugal blower 10 of the present embodiment, the centrifugal fan 20 rotates when the controller starts the electric motor. Accordingly, air around the surface of the seat S is drawn from the suction port 30a of the case 30 and is blown from the blowing port 30b. The centrifugal blower 10 of the present embodiment draws the air from the vehicle compartment in the seat air conditioner by operating as described above.

This kind of centrifugal blower rotates a centrifugal fan in a case. Therefore, a fan efficiency ηf can be improved by suppressing a sliding friction between the centrifugal fan and the case and by reducing a rotational driving force (i.e., a shaft force) that is required to rotate the centrifugal fan. Thus, similar to the centrifugal blower 10 of the present embodiment, the centrifugal fan is arranged not to be in contact with the case.

However, when a dimension of a gap formed between the centrifugal fan and the case is set to be large to prevent the centrifugal fan and the case from being in contact with each other, the air blown from the centrifugal fan counterflows toward the suction port, and the fan efficiency ηf may deteriorate.

According to the centrifugal blower 10 of the present embodiment, the grease G fills a gap between the two case-side protruding parts 31b, and the tip portion 22b of the fan-side protruding part 22a is in contact with the grease G. Accordingly, the air blown from the centrifugal fan 20 can be prevented from counterflowing toward the suction port 30a through the gap formed between the suction-side surface 31a of the case 30 and the upper-surface-side plate 22 of the centrifugal fan 20.

Therefore, a deterioration of the fan efficiency ηf, which causes when air blown from the centrifugal fan 20 is re-drawn from the fan-side suction hole 20a, can be suppressed.

In the centrifugal blower 10 having the centrifugal fan 20 constituted as the backward inclined fan, an air pressure (i.e., a blowing pressure) on a blowing side of the centrifugal fan 20 may easily become higher than an air pressure (i.e., a suction pressure) on an inlet side of the centrifugal fan 20. Accordingly, air blown from the centrifugal fan 20 counterflows toward the suction port 30a easily. Therefore, in the centrifugal blower having the backward inclined fan, restricting the counterflow as the present embodiment is greatly effective to improve the fan efficiency ηf.

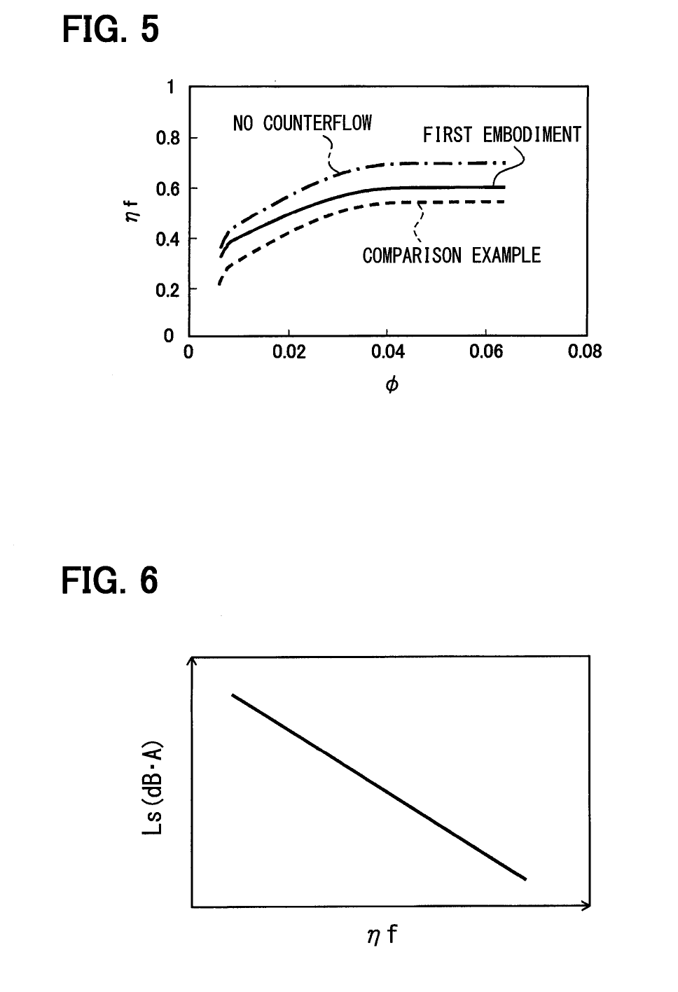

More specifically, according to studies conducted by the inventors of the present disclosure, the fan efficiency ηf can improve by about 15% as shown as a change from a dash line to a one dot line in FIG. 5 by suppressing the counterflow while restricting an increase of the shaft force of the centrifugal fan 20 in a centrifugal blower in which the gap between the two case-side protruding parts 31b is not filled with the grease G as compared to the present embodiment. The centrifugal blower in which the gap between the two case-side protruding parts 31b is not filled with the grease G is, in other words, a centrifugal blower as a comparison example in which the counterflow may be caused. The centrifugal blower as the comparison example will be referred to as a comparison blower. According to the comparison blower, although the counterflow may be caused, the sliding friction may not be caused between the centrifugal fan 20 and the grease G.

Further, in the centrifugal blower 10 of the present embodiment, the centrifugal fan 20 and the case 30 are not in contact with each other directly. Accordingly, an increase of the sliding friction between the centrifugal fan 20 and the case 30 can be suppressed. In addition, the tip portion 22b of the fan-side protruding part 22a has the axial cross section of which sectional shape is tapered gradually toward the protruding direction in which the fan-side protruding part 22a protrudes. Therefore, by decreasing a contact area between the fan-side protruding part 22a and the grease G, an increase of the sliding friction between the fan-side protruding part 22a and the grease G fan can be suppressed.

Specifically, an area of the tip portion 22b of the fan-side protruding part 22a being in contact with the grease G is defined as an area A, and a relative speed between the fan-side protruding part 22a and the grease G when rotating the centrifugal fan 20 is defined as a relative speed U. A load F applied to the fan-side protruding part 22a is calculated by the following formula F1. The load F corresponds to a sliding friction between the fan-side protruding part 22a and the grease G.

F=μ×(A×U)/h (F1)

Here, μ is a viscosity of the grease G, and h is a thickness of the grease G.

The inventors of the present disclosure examined and found that the counterflow can be suppressed with an increase by 10% of the shaft force according to the centrifugal blower 10 of the present embodiment as compared to the comparison blower.

That is, according to the centrifugal blower 10 of the present embodiment, the air blown from the centrifugal fan 20 can be prevented from counterflowing toward a suction port 30a of the case 30, and the increase of the shaft power of the centrifugal fan 20 can be suppressed. As a result, according to the centrifugal blower 10 of the present embodiment, as shown by a solid line in FIG. 5, the fan efficiency ηf can be improved by about 5% with respect to the comparison blower.

According to a conventional blower, as shown in FIG. 6, a relative noise Ls of the blower can be reduced by improving the fan efficiency ηf. Thus, according to the centrifugal blower 10 of the present embodiment, the relative noise Ls can be reduced by the above-described effect improving the fan efficiency ηf.

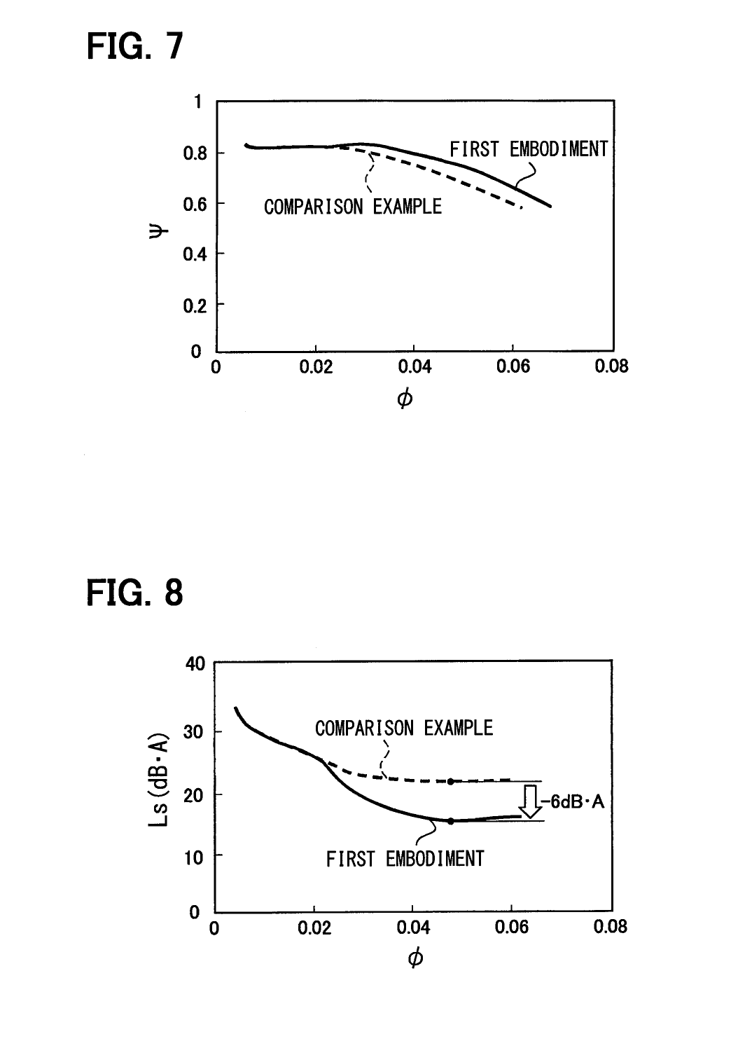

More specifically, according to the centrifugal blower 10 of the present embodiment, by the above-described effect improving the fan efficiency ηf, a pressure coefficient ψ relative to a flow coefficient φ can be improved as shown by a solid line in FIG. 7 as compared that of the comparison blower shown by a dash line. That is, it means that a required operational point (i.e., an air volume and a pressure) can be secured with a low rotational speed according to the centrifugal blower 10 of the present embodiment as compared to the comparison blower.

Therefore, according to the centrifugal blower 10 of the present embodiment, as shown by a solid line in FIG. 8, the relative noise Ls at the required operational point can be reduced as compared to that of the comparison blower shown by a dash line. The flow coefficient φ and the pressure coefficient ψ shown in FIGS. 5 to 8 are dimensionless values of an air volume (i.e., a flow amount) of air blowing from the blower and an air pressure of air blowing from the blower, respectively, for comparing performances of the two fans under the same operational condition. The same operational condition is, for example, a condition where the two fans are formed to have the same fan diameter, and where the two fans are operated at the same rotational speed.

According to the centrifugal blower 10 of the present embodiment, the grease G made of a semisolid material is used as the sealing member. Therefore, the tip portion 22b of the fan-side protruding part 22a can be in contact with the grease G easily even if a dimension of the fan-side protruding part 22a is slightly different from a required dimension when forming the fan-side protruding part 22a. That is, when forming the fan-side protruding part 22a, the fan-side protruding part 22a can be formed easily without an advanced tolerance management.

According to the present embodiment, the centrifugal blower 10 has multiple case-side protruding parts 31b, and the gap formed between adjacent case-side protruding parts 31b is filled with the grease G. Therefore, an increase of the shaft force due to an increase of a weight of the centrifugal fan 20 is suppressed as compared to a case where multiple fan-side protruding parts 22aare disposed, and where a gap formed between adjacent fan-side protruding parts 22a is filled with the grease G. Moreover, the grease G is fallen off due to a centrifugal force caused when the centrifugal fan 20 rotates.

Further, according to the centrifugal blower 10 of the present embodiment, the case-side protruding part 31b and the fan-side protruding part 22a are located to be closer to the innermost periphery (i.e., the fan-side suction hole 20a) of the upper-surface-side plate 22 than the outermost periphery of the upper-surface-side plate 22. Accordingly, the contact area between the fan-side protruding part 22a and the grease G can decrease as compared to a case where the case-side protruding part 31b and the fan-side protruding part 22a are located to be closer to the outermost periphery than the innermost periphery. Therefore, an increase of the sliding friction between the fan-side protruding part 22a and the grease G fan can be effectively suppressed.

Moreover, according to the centrifugal blower 10 of the present embodiment, the fan-side protruding part 22a is located to be closer to the outer periphery of the upper-surface-side plate 22 than the innermost periphery (i.e., the fan-side suction hole 20a) of the upper-surface-side plate 22. Thus, the fan-side protruding part 22a can be formed easily and certainly to have the annular shape that fits to the case-side protruding part 31b without being affected by a shape of the fan-side suction hole 20a.

### Second Embodiment

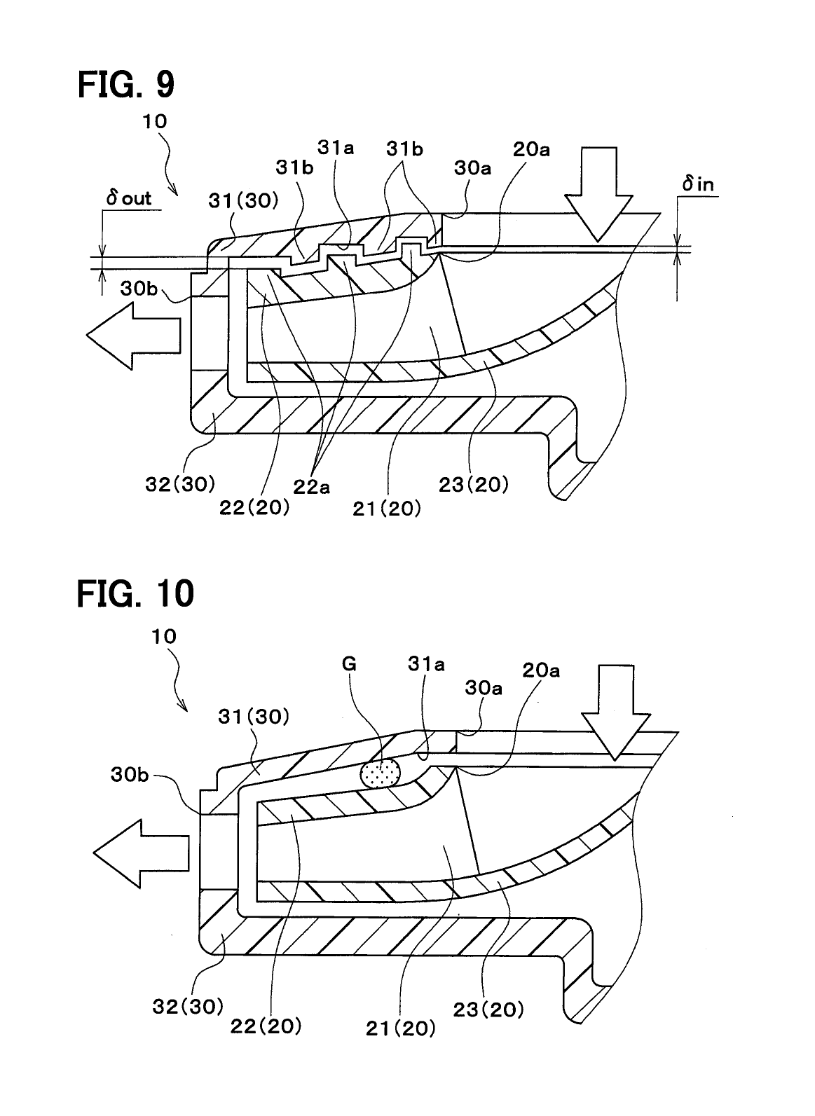

In the present embodiment, an example in which a structure of the case-side protruding part 31b and a structure of the fan-side protruding part 22a are changed as shown in FIG. 9 will be described. FIG. 9 is a drawing corresponding to FIG. 4 of the first embodiment, and a part that corresponds to a matter described in the first embodiment may be assigned with the same reference number. This is the same also in FIGS. 10 to 12.

Specifically, more than one of the case-side protruding parts 31b and more than one of the fun-side protruding parts 22a are provided (e.g., the quantity is three in the present embodiment). As shown in an axial cross section of FIG. 9, a diameter of each case-side protruding part 31b and a diameter of each fan-side protruding part 22a increase one by one by turns. That is, the case-side protruding parts 31b and the fan-side protruding parts 22a are arranged alternately in the radial direction when viewed in the axial direction of the rotational axis.

By arranging the case-side protruding parts 31b and the fan-side protruding parts 22a, which protrude to face each other, alternately in the radial direction, the case-side protruding parts 31b and the fan-side protruding parts 22a of the present embodiment configure a labyrinth seal structure in the gap formed between the suction-side surface 31a of the case 30 and the upper-surface-side plate 22 of the centrifugal fan 20.

Further, according to the present embodiment, as shown in FIG. 9, a dimension δin between the suction-side surface 31a and the upper-surface-side plate 22 on an inner peripheral side of the labyrinth seal structure is smaller than a dimension δout between the suction-side surface 31a and the upper-surface-side plate 22 on an outer peripheral side of the labyrinth seal structure. Other configurations and operations of the centrifugal blower 10 are the same as that of the first embodiment.

Accordingly, when the centrifugal blower 10 of the present embodiment is operated, the centrifugal blower 10 can draw air from the vehicle compartment in the seat air conditioner similar to the first embodiment.

Moreover, according to the centrifugal blower 10 of the present embodiment, the case-side protruding parts 31b and the fan-side protruding parts 22a constitute the labyrinth seal in the gap formed between the suction-side surface 31a and the upper-surface-side plate 22. The dimension δin of the gap on an inner peripheral side (i.e., a rotational axis side) of the labyrinth seal is smaller than the dimension δout of the gap on an outer peripheral side of the labyrinth seal.

Accordingly, the air blown from the centrifugal fan 20 can be effectively prevented from counterflowing toward the suction port 30a through the gap formed between the suction-side surface 31a of the case 30 and the upper-surface-side plate 22 of the centrifugal fan 20.

Furthermore, according to the centrifugal blower 10 of the present embodiment, since the centrifugal fan 20 and the case 30 are not in contact with each other directly, the sliding friction between the centrifugal fan 20 and the case 30 can be suppressed. In this case, a displacement amount of the centrifugal fan 20 due to a vibration or the like is smaller on the inner peripheral side (i.e., the rotational axis side) than on the outer peripheral side. Therefore, an increase of the sliding friction, which is caused when a portion of the centrifugal fan 20 and a portion of the case 30 forming an inner periphery of the labyrinth seal are in contact with each other, can be suppressed.

That is, according to the centrifugal blower 10 of the present embodiment, the air blown from the centrifugal fan 20 can be prevented from counterflowing toward the suction port 30a, and the increase of the shaft power of the centrifugal fan 20 can be suppressed.

### Third Embodiment

In the present embodiment, a modification example of the first embodiment will be described. According to a centrifugal blower 10 of the present embodiment, as shown in FIG. 10, the fan-side protruding part 22a and the case-side protruding part 31b are omitted with respect to the first embodiment.

Accordingly, the grease G of the present embodiment is arranged in a gap defined between the suction-side surface 31a of the case 30 and the upper-surface-side plate 22 of the centrifugal fan 20. Further, the grease G is in contact with both the suction-side surface 31a and the upper-surface-side plate 22 and is disposed around the rotational axis to have an annular shape when viewed in the axial direction. Other configurations are the same as that of the first embodiment.

Accordingly, when the centrifugal blower 10 of the present embodiment is operated, the centrifugal blower 10 can draw air from the vehicle compartment in the seat air conditioner similar to the first embodiment.

“The grease G is in contact with both the suction-side surface 31a and the upper-surface-side plate 22” is not limited to a meaning that the grease G is in contact with a portion or the suction-side surface 31a and a portion of the upper-surface-side plate 22 that are formed in a sheet shape.

For example, in a case where the suction-side surface 31a or the upper-surface-side plate 22 has a protruding part or a recessed part, the grease G may be in contact with a tip portion of the protruding part or with an inside of the recessed part.

According to the centrifugal blower 10 of present embodiment, the grease G as the sealing member is arranged in the gap between the suction-side surface 31a and the upper-surface-side plate 22. Accordingly, similar to the first embodiment, the air blown from the centrifugal fan 20 can be prevented from counterflowing toward the suction port 30a through the gap formed between the suction-side surface 31a and the upper-surface-side plate 22.

As described above, in the centrifugal blower 10 of the present embodiment, the fan-side protruding part 22a and the case-side protruding part 31b are omitted. Therefore, the above-described effect for suppressing the counterflow can be achieved with a greatly simple structure in which the grease G is arranged in the gap formed between the suction-side surface 31a and the upper-surface-side plate 22.

On the other hand, with the centrifugal blower 10 of present embodiment, since centrifugal force acts on the grease G due to a rotation of the centrifugal fan 20, the grease G easily moves to the outer peripheral side. Therefore, the centrifugal blower 10 of the present embodiment is preferably used as a centrifugal blower that rotates the centrifugal fan 20 in a lower rotational speed range as compared to the first embodiment.

Further, in the centrifugal blower 10 of the present embodiment, a dimension of the gap between the suction-side surface 31a and the upper-surface-side plate 22 is preferably shortened to restrict a separation of the sealing member.

### Fourth Embodiment

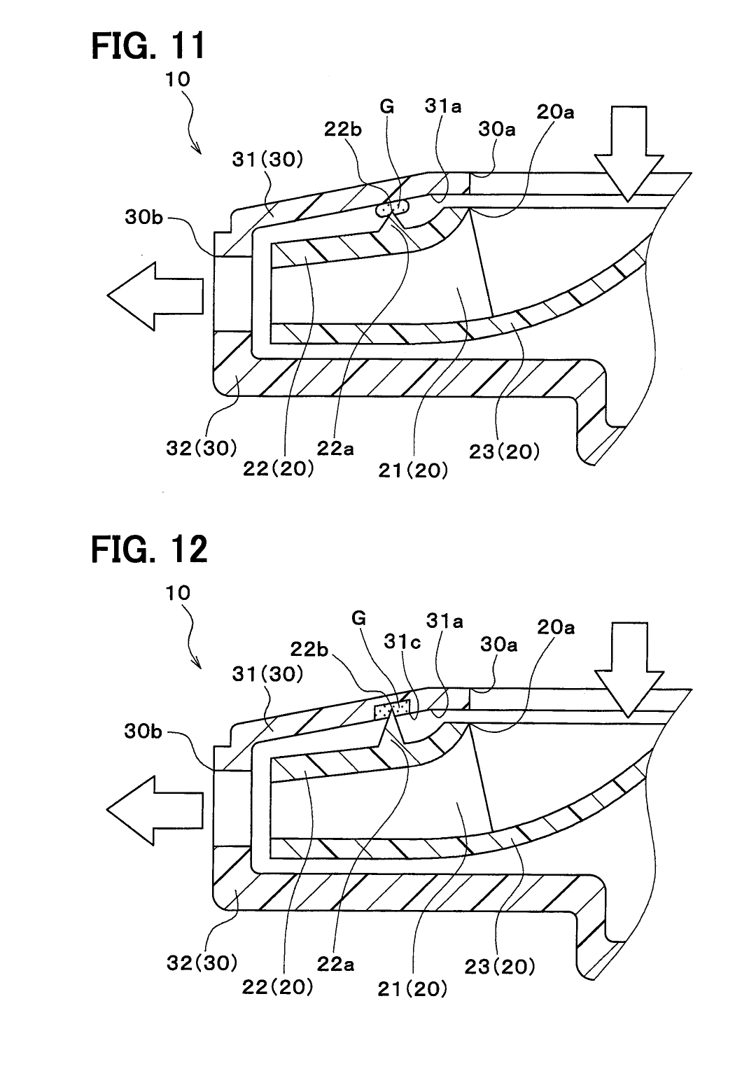

In the present embodiment, a modification example of the first embodiment will be described. In a centrifugal blower 10 of the present embodiment, as shown in FIG. 11, the case-side protruding part 31b is omitted with respect to the first embodiment. The tip portion 22b of the fan-side protruding part 22a of the upper-surface-side plate 22 is in contact with the grease G that is arranged in the gap formed between the suction-side surface 31a and the upper-surface-side plate 22. Other configurations are the same as that of the first embodiment.

Accordingly, when the centrifugal blower 10 of the present embodiment is operated, the centrifugal blower 10 can draw air from the vehicle compartment in the seat air conditioner similar to the first embodiment. Moreover, the same effect as the first embodiment that the air blown from the centrifugal fan 20 can be prevented from counterflowing toward the suction port 30a through the gap formed between the suction-side surface 31a and the upper-surface-side plate 22 can be achieved.

### Fifth Embodiment

In the present embodiment, a modification example of the first embodiment will be described. In a centrifugal blower 10 of the present embodiment, with respect to the first embodiment, the case-side protruding part 31b is omitted, and the suction-side surface 31a of the case 30 has a recessed part 31c that is provided with a surface located on a side facing the upper-surface-side plate 22 as shown in FIG. 12.

The recessed part 31c is formed in an annular shape around the rotational axis when viewed in the axial direction and is recessed toward a side in a direction away from the fan-side protruding part 22a. The fan-side protruding part 22a and the recessed part 31c are arranged to overlap with each other when viewed in the axial direction. The fan-side protruding part 22a protrudes such that the tip portion 22b reaches to an inside of the recessed part 31c.

Furthermore, the grease G of the present embodiment fills the inside of the recessed part 31c all along the recessed part 31c. The tip portion 22b of the fan-side protruding part 22a is in contact with the grease G that fills the inside of the recessed part 31c. Other configurations are the same as that of the first embodiment.

Accordingly, when the centrifugal blower 10 of the present embodiment is operated, the centrifugal blower 10 can draw air from the vehicle compartment in the seat air conditioner similar to the first embodiment. Moreover, the same effect as the first embodiment where the air blown from the centrifugal fan 20 can be prevented from counterflowing toward the suction port 30a through the gap formed between the suction-side surface 31a and the upper-surface-side plate 22 can be achieved.

### Other Modifications

It should be understood that the present disclosure is not limited to the above-described embodiments and intended to cover various modification within a scope of the present disclosure as described hereafter.

(1) In the above-described first embodiment, an example in which the case-side protruding part 31b provides the one protruding part described in claims is described. However, more than one of the fan-side protruding parts 22a may be provided such that the fan-side protruding part 22a configures the one protruding part, and that the case-side protruding part 31b configures the other protruding part.

Further, a quantity of the case-side protruding part 31b and a quantity of the fan-side protruding part 22a are not limited to a quantity that is described in the first embodiment, and a quantity of both the case-side protruding part 31b and the fan-side protruding part 22a may be more than one.

In the above-described second embodiment, an example in which the quantity of the case-side protruding part 31b and the quantity of the fan-side protruding part 22a is three is described. However, as long as the labyrinth seal can be configured, the quantity of the case-side protruding part 31b and the quantity of the fan-side protruding part 22a is not limited to the example.

In the above-described fourth embodiment, an example in which the case-side protruding part 31b is omitted is described. However, the fan-side protruding part 22a may be omitted. In this case, one case-side protruding part 31b is formed, and a tip portion of the one case-side protruding part 31b may have an axial cross section of which sectional shape is tapered gradually toward a direction in which the one case-side protruding part protrudes.

In the above-described fifth embodiment, an example in which the case-side protruding part 31b is omitted, and in which the recessed part 31c is formed in the case 30 is described. However, the fan-side protruding part 22a may be omitted, and a recessed part may be formed in the upper-surface-side plate 22. In this case, one case-side protruding part 31b is formed, and a tip portion of the case-side protruding part 31b may be in contact with the grease G that is arranged inside of the recessed part formed in the upper-surface-side plate 22.

(2) In the above-described first, fourth, and fifth embodiments, the tip portion of the fan-side protruding part 22a has the sectional shape in the axial cross section that is tapered to form an acute angle. However, a sectional shape of the tip portion of the fan-side protruding part 22a is not limited to the example. For example, the sectional shape may be formed in a semicircle shape, or may be formed in a semi-ellipse shape.

As described above, when the case-side protruding part 31b configures the one protruding part (or the other protruding part), the sectional shape of the case-side protruding part 31b in an axial cross section may be tapered toward the direction in which the case-side protruding part 31b protrudes.

(3) In the above-described first embodiment, an example in which the grease G is used as the sealing member made of a semisolid material is described. However, the sealing member is not limited to the example. For example, a material such as magnetic fluid may be used as long as the material has both a liquid property and a solid property and has a specified viscosity and a specific kinetic viscosity.

According to examinations conducted by the inventors of the present disclosure, the grease G is retained between the case-side protruding parts 31b when the centrifugal blower 10 is operated even in a case where the case-side protruding parts 31b is arranged to protrude downward in a vertical direction, for example, by using a material having a consistency that is about 250 (±10%).

(4) In the above-described embodiments, an example in which the centrifugal fan 20 and the case 30 of the centrifugal blower 10 is made of resin is described. Specifically, the centrifugal fan 20 and the case 30 may be made of polypropylene. Further, a material making each component of the centrifugal fan 20 and the case 30 is not limited as long as the each component exerts its function. Accordingly, the each component may be made of a material such as metal.

(5) In the above-described embodiments, an example in which the backward inclined fan (i.e., the turbo fan) is used as the centrifugal fan 20 is described. However, the centrifugal fan 20 is not limited to the example. For example, a frontward inclined fan (i.e., a sirocco fan) in which blades are formed in a shape inclining in the rotational direction from the radial inner side to the radial outer side may be used as the centrifugal fan 20.

(6) In the above-described embodiments, an example in which the centrifugal blower 10 of the present disclosure is used for the seat air conditioner for a vehicle is described. However, a usage of the centrifugal blower 10 is not limited to the example. For example, the centrifugal blower 10 may be used for a cooling blower cooling CPU of a personal computer or may be used for an electric vacuum cleaner.

What is claimed is:

1. A centrifugal blower comprising:
a centrifugal fan that rotates by a rotational driving force transmitted thereto, draws air in an axial direction of a rotational axis, and blows the air in a radial direction; and
a case that houses the centrifugal fan and is provided with a suction port for the air, wherein
the centrifugal fan has:
a plurality of blades (that are arranged annularly around the rotational axis; and
an upper-surface-side plate to which the plurality of blades are fixed, the upper-surface-side plate that is arranged to face an suction-side surface of the case) provided with the suction port,
the upper-surface-side plate has a protruding part that has an annular shape when viewed in the axial direction and protrudes toward the suction-side surface,
the suction-side surface and the upper-surface-side plate form a gap therebetween, and a sealing member made of a semisolid material is disposed in the gap, and
the sealing member is disposed on a side adjacent to the suction-side surface to be in contact with both the suction-side surface and the upper-surface-side plate and is disposed around the rotational axis to have an annular shape when viewed in the axial direction.

2. The centrifugal blower according to claim 1, wherein
the protruding part has a tip portion) that is in contact with the sealing member and,
the tip portion has an axial cross section of which sectional shape is tapered gradually toward a direction in which the protruding part protrudes.

3. The centrifugal blower according to claim 1, wherein the suction-side has a recessed part that has an annular shape when viewed in the axial direction and is recessed toward a side in a direction away from the protruding part.

4. (canceled)

5. The centrifugal blower according to claim 1, wherein
the suction-side surface has a case-side protruding part that is formed in an annular shape when viewed in the axial direction and protrudes toward the upper-surface-side plate,
at least one of the case-side protruding part and the fan-side protruding part is one protruding part of a plurality of protruding parts,
the sealing member is disposed between adjacent protruding parts of the plurality of protruding parts,
an other one of the case-side protruding part and the fan-side protruding part has a tip portion that is in contact with the sealing member.

6. The centrifugal blower according to claim 5, wherein
the one of the case-side protruding part and the fan-side protruding part is the case-side protruding part, and
the other one of the case-side protruding part and the fan-side protruding part is the fan-side protruding part.

7. The centrifugal blower according to claim 1, wherein
the fan-side protruding part is located to be closer to an outer periphery of the upper-surface-side plate than an innermost periphery of the upper-surface-side plate.

8. The centrifugal blower according to claim 1, wherein
the fan-side protruding part is located to be closer to an innermost periphery of the upper-surface-side plate than to an outermost portion of the upper-surface-side plate.

9.-13. (canceled)

14. The centrifugal blower according to claim 3, wherein
the protruding part and the recessed part are arranged to overlap with each other when viewed in the axial direction,
the sealing member is disposed inside of the recessed part.
